(19) United States
(12) Patent Application Publication
(10) Pub. No.: US 2026/0335173 A1
(43) Pub. Date: Oct. 29, 2026

(54) MASSAGE APPARATUS

(71) Applicant: XIAMEN COMFIER TECHNOLOGY CO.,LTD., Fujian (CN)

(72) Inventors: Jianqing LI, Fujian (CN); Zhicheng ZHANG, Fujian (CN); Lei LENG, Fujian (CN)

(21) Appl. No.: 19/117,691

(22) PCT Filed: Mar. 21, 2024
(86) PCT No.: PCT/CN2024/083033

§ 371 Date: Apr. 2, 2025

(30) Foreign Application Priority Data
May 12, 2023 (CN) 202321136475.4

(51) Int. Cl. A61H 7/00

(52) U.S. Cl. CPC A61H 7/007; A61H 2007/009; A61H 2201/1215; A61H 2201/123; A61H 2205/04; A61H 2205/062

(57) ABSTRACT

A massage apparatus. First massage units (5) and second massage units (6) are connected to a transmission shaft (43) respectively and swing by means of the rotation of the transmission shaft the transmission shaft (43) extends from left to right and a first eccentric wheel is fixedly provided on corresponding one side of the transmission shaft (43); each first massage unit (5) comprises a first rocker arm (51) extending forwards; a first massage head (52) is mounted at the front end of the first rocker arm (51); a first connecting sleeve hole (53) is formed in the rear end of the first rocker arm (51); the first connecting sleeve hole (53) is rotatably combined with a corresponding first eccentric wheel a first limiting column (54) extends downwards from the bottom of the rear end of each first rocker arm (51); the first limiting column (54) moves up and down and is limited in a front-back direction, and is inserted into a first limiting slot (71) below the transmission shaft (43); and the depth of the first limiting slot(71) allows the first limiting column (54) to move up and down. The massage apparatus has a simple structure, can ensure the structural strength of the first rocker arms (51), and is convenient and quick to assemble.

### TECHNICAL FIELD

The present invention relates to the technical field of massage apparatus.

### BACKGROUND OF THE INVENTION

There are various types of massage apparatus available in the market, capable of providing kneading massages to the shoulders or the neck of a user to alleviate muscle fatigue in these areas.

For example, CN 208096962 U discloses a shoulder and neck massager, comprising an upper cover, a lower cover, a power apparatus, a transmission apparatus, a neck massage apparatus, and a shoulder massage apparatus, wherein the shoulder massage apparatus comprises a synchronous wheel shaft, eccentric wheels, eccentric shafts, small massage arms, and small massage balls; each of the small massage arms is provided with an elongated through hole, the eccentric shafts are inserted into respective elongated through holes respectively, and the small massage balls are rotatably installed at second ends of the small massage arms respectively. This solution can achieve the massage of shoulders and neck synchronously, but the small massage arms of the shoulder massage apparatus needs to be equipped with independent eccentric wheels, eccentric shafts and elongated through holes for oscillation and position limitation, and so the structures are relatively complicated, which is unfavorable for production and assembly.

In another example, CN 217245440 U discloses a massage machine core, which comprises a housing and a drive unit inside the housing, a shoulder massage mechanism, a neck massage mechanism and a back massage mechanism which are arranged in the housing, wherein the shoulder massage mechanism and the neck massage mechanism share a first drive shaft, but a first massage arm of the shoulder massage mechanism still needs to be provided with an arc-shaped guide groove, through which a guide bar penetrates for position limitation. The arc-shaped guide groove reduces the structural strength of the first massage arm, and also presents the problems of structural complication and assembly difficulty.

In view of the above, a massage apparatus is proposed to solve the above problems.

BRIEF SUMMARY OF THE INVENTION It is an object of the present invention to provide a massage apparatus which has the advantages of compact structure and quickness in assembly.

To achieve the above object, the present invention adopts the following technical solutions:

A massage apparatus, comprising a massage machine core; the massage machine core comprises a drive unit, a transmission unit, a plurality of first massage units, and a plurality of second massage units; the drive unit drives a transmission shaft of the transmission unit to rotate; the plurality of first massage units and the plurality of second massage units are all connected to the transmission shaft and driven by rotation of the transmission shaft to at least oscillate;
each of said plurality of first massage units is capable of at least oscillating along a front-rear direction of the massage apparatus; the transmission shaft extends along a left-right direction of the massage apparatus, and each of two sides of the transmission shaft is fixed with at least one first eccentric wheel; each of said plurality of first massage units comprises a first rocker arm extending forward towards a front side of the massage apparatus, a first massage head installed at a front end of the first rocker arm, and a first connection sleeve hole formed at a rear end of the first rocker arm; the first connection sleeve hole rotatably receives a corresponding first eccentric wheel; a first limiting column is also provided extending downwardly from a bottom side of the rear end of the first rocker arm;
   a first limiting groove, formed below the transmission shaft, is provided for each of said plurality of first massage units; the first limiting column of each of said plurality of first massage units is inserted into a respective first limiting groove, such that the first limiting column is vertically movable in the first limiting groove but limited from moving back and forth in the first limiting groove along the front-rear direction of the massage apparatus, and wherein a depth of the first limiting groove allows the first limiting column to be vertically movable therein, and at least a portion of the first limiting column has a thickness along the front-rear direction of the massage apparatus smaller than a distance between a front side wall and a rear side wall of the first limiting groove at least at an opening of the first limiting groove, so that a clearance exists between said at least a portion of the first limiting column and at least the opening of the first limiting groove.

Further, the massage machine core also comprises a machine core lower shell; the drive unit, the transmission unit, said plurality of first massage units, and said plurality of second massage units are mounted on an upper side of the machine core lower shell; the first limiting groove is formed in the machine core lower shell.

Further, the massage machine core also comprises a machine core lower shell; the drive unit, the transmission unit, said plurality of first massage units, and said plurality of second massage units are mounted on an upper side of the machine core lower shell; the first limiting groove is formed on a limiting block, and the limiting block is fixed and locked on the machine core lower shell, and the limiting block is made of wear-resistant material.

Further, each of said plurality of second massage units is capable of at least oscillating along the left-right direction of the massage apparatus; each of said two sides of the transmission shaft is also fixed with at least one second eccentric wheel assembly positioned on an outer side of said at least one first eccentric wheel;
each of said plurality of second massage units comprises a second rocker arm extending upwardly, a second massage head installed at an upper end of the second rocker arm, and a second connection sleeve hole formed at a lower end of the second rocker arm; the second connection sleeve hole rotatably receives a corresponding second eccentric wheel assembly, and a second limiting column is provided extending downwardly from a bottom side of the lower end of the second rocker arm;
a second limiting groove, formed below the transmission shaft, is provided for each of said plurality of second massage units; the second limiting column of each of said plurality of second massage units is inserted into a respective second limiting groove, such that the second limiting column is horizontally movable along the left-right direction of the massage apparatus but limited from moving back and forth along the front-rear direction of the massage apparatus; the second limiting groove is disposed on an outer side of the first limiting groove; a depth of the second limiting groove corresponds to a length of the second limiting column; the second limiting groove extends along the left-right direction of the massage apparatus to enable the second limiting column to oscillate along the left-right direction of the massage apparatus;
each of said at least one second eccentric wheel assembly comprises an inner eccentric wheel and an outer eccentric wheel; opposite surfaces of the inner eccentric wheel and the outer eccentric wheel are arranged as corresponding inclined surfaces; the inclined surface of the inner eccentric wheel facing towards the inclined surface of the outer eccentric wheel is provided with an inner eccentric wheel connection part; the transmission shaft eccentrically penetrates through each of said at least one second eccentric wheel assembly; an axis of the inner eccentric wheel connection part is tilted with respect to an axis of the transmission shaft, and the inner eccentric wheel connection part is rotatably inserted into the second connection sleeve hole of the second rocker arm of a corresponding second massage unit.

Further, the first limiting groove and the second limiting groove are formed on a limiting block; the limiting block is fixed and locked on a machine core lower shell of the massage machine core, and the limiting block is made of wear-resistant material.

Further, an outer end of the first limiting column is provided with reinforcing protrusions protruding towards a front side and a rear side of the first limiting column respectively; said clearance exists between the thickness along the front-rear direction of the massage apparatus of a portion of the first limiting column above the reinforcing protrusions and the distance between the front side wall and the rear side wall of the first limiting groove; a front-rear thickness of the outer end of the first limiting column where the reinforcing protrusions are provided is equal to the distance between the front side wall and the rear side wall of the first limiting groove.

Further, a side surface of each of the reinforcing protrusions is an arc surface.

Further, each of said two sides of the transmission shaft is provided with at least one of said plurality of first massage units and at least one of said plurality of second massage units.

Further, the massage apparatus also comprises a machine core upper cover and a machine core lower shell;
the drive unit is installed in an installation space defined by an enclosure formed by the machine core upper cover and the machine core lower shell connected to each other, and the drive unit comprises a drive motor, a battery, and a worm connected to an output end of the drive motor; the battery is configured to supply power to the drive motor;
the transmission unit also comprises a worm wheel and a transmission wheel; the worm wheel is rotatably installed in the installation space and comprises a helical gear and a spur gear which are coaxially arranged; the helical gear and the worm engage with each other, the spur gear and the transmission wheel engage with each other; the transmission wheel is coaxially fixed with the transmission shaft.

Further, two tail ends of said two sides of the transmission shaft are rotatably connected to outer shaft sleeves respectively, and the outer shaft sleeves are fixedly installed on a periphery of the machine core lower shell.

According to the above technical solutions, on each side of the massage machine core, when the first eccentric wheel rotates, the first limiting column of the first massage unit reciprocates vertically in the first limiting groove and being limited to move back and forth along a front-rear direction so as to limit the direction and amplitude of the movement of the first rocker arm of the first massage unit; accordingly, the first massage head connected to the front end of the first rocker arm is driven by the first rocker arm to reciprocate vertically and also oscillate back and forth along the front-rear direction to achieve a circular or elliptical motion, such that the first massage head can perform kneading massages on a shoulder of the user. Compared with the prior art, the massage apparatus of the present invention does not need a guide groove on the first rocker arm or a guide bar, so that the structures of the massage apparatus are simpler; according to the present invention, the structural strength of the first rocker arm can be ensured, and the assembly of the massage apparatus is more convenient and rapid, and the massage apparatus has a more compact structure.

### BRIEF DESCRIPTION OF THE DRAWINGS

FIG. 1 is a perspective view of an embodiment of the present invention.

FIG. 2 is an exploded view of an embodiment of the present invention.

FIG. 3 is a sectional view of an embodiment of the present invention.

FIG. 4 is a first schematic diagram of a partial structure of an embodiment of the present invention.

FIG. 5 is a second schematic diagram of a partial structure of an embodiment of the present invention.

FIG. 6 is a third schematic diagram of a partial structure of an embodiment of the present invention.

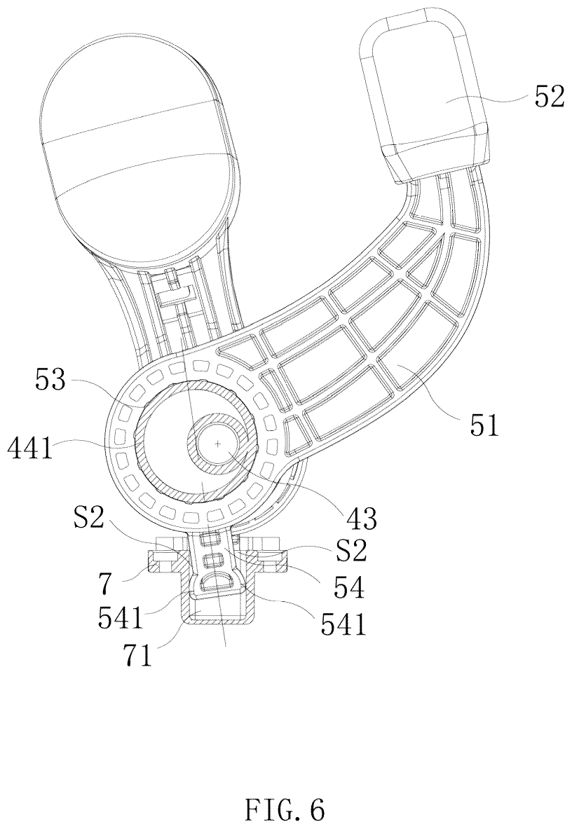

Description of reference numerals: massage machine core 10, machine core upper cover 1, machine core lower shell 2, installation space S1, drive unit 3, drive motor 31, battery 32, worm 33, transmission unit 4, worm wheel 41, helical gear 411, spur gear 412, transmission wheel 42, transmission shaft 43, first eccentric wheel 44, first eccentric wheel connection part 441, second eccentric wheel assembly 45, inner eccentric wheel 451, outer eccentric wheel 452, inner eccentric wheel connection part 453, outer shaft sleeve 46, inner shaft sleeve 47, first massage unit 5, first rocker arm 51, first massage head 52, first connection sleeve hole 53, first limiting column 54, reinforcing part 541, side surface 5411, second massage unit 6, second rocker arm 61, second massage head 62, second connection sleeve hole 63, second limiting column 64, limiting block 7, first limiting groove 71, second limiting groove 72, clearance S2, and housing 20.

### DETAILED DESCRIPTION OF THE INVENTION

To make the object, technical solutions, and advantages of the embodiments of the present application clearer, the technical solutions in the embodiments of the present application will be clearly and thoroughly described hereinafter with reference to the drawings in the embodiments of the present application.

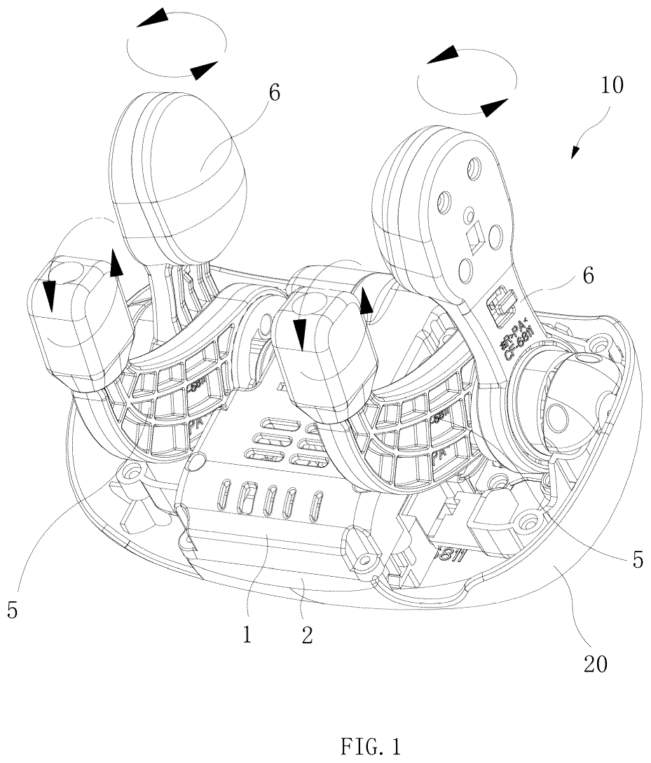

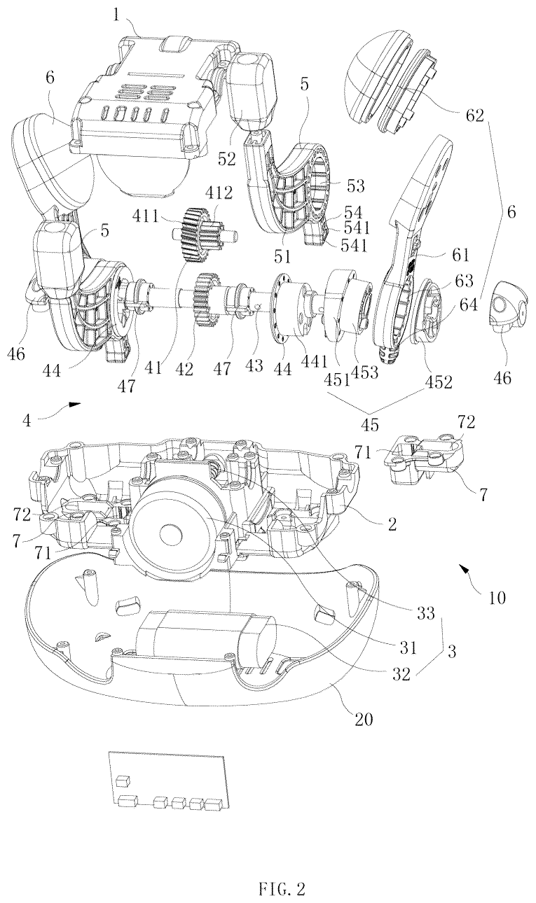

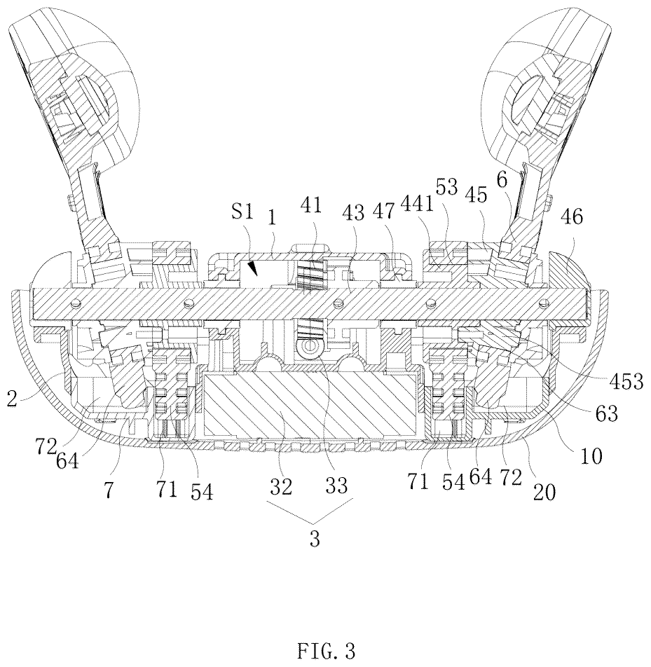

As shown in FIGS. 1 to 3, a massage apparatus of the present invention comprises a housing 20 and a massage machine core 10 installed in the housing 20.

The massage machine core 10 comprises a machine core upper cover 1, a machine core lower shell 2, a drive unit 3, a transmission unit 4, a plurality of first massage units 5, and a plurality of second massage units 6. Said plurality of first massage units 5 comprises two first massage units 5 spaced apart from each other by being symmetrically arranged on two sides of the massage machine core 10 respectively. Said plurality of second massage units 6 comprises two second massage units 6 spaced apart from each other by being symmetrically arranged on the two sides of the massage machine core 10 respectively, and the two second massage units 6 are located on outer sides of the two first massage units 5 respectively.

Said plurality of first massage units 5 may be configured to massage the shoulders of a user, and said plurality of second massage units 6 may be configured to massage the neck of the user.

The drive unit 3 is installed in an installation space S1 defined by an enclosure formed by the machine core upper cover 1 and the machine core lower shell 2 connected to each other, and the drive unit 3 comprises a drive motor 31, a battery 32, and a worm 33 connected to an output end of the drive motor 31. The battery 32 is configured to supply power to the drive motor 31.

The transmission unit 4 comprises a worm wheel 41, a transmission wheel 42, a transmission shaft 43, a plurality of first eccentric wheels 44, and a plurality of second eccentric wheel assemblies 45. Said plurality of first eccentric wheels 44 comprises two first eccentric wheels 44 corresponding to the two first massage units 5 respectively, and said second eccentric wheel assemblies 45 comprises two second eccentric wheel assemblies 45 as well corresponding to the two second massage units 6.

The worm wheel 41 is rotatably installed in the installation space S1 and comprises a helical gear 411 and a spur gear 412 which are coaxially arranged. The helical gear 411 and the worm 33 engage with each other, the spur gear 412 and the transmission wheel 42 engage with each other; the transmission wheel 42 is coaxially fixed with the transmission shaft 43, such that the drive motor 31 can drive the transmission shaft 43 to rotate.

Left and right sides of the transmission shaft 43 extend out of two sides of the installation space S1 respectively, each of the left and right sides of the transmission shaft 43 is mounted with a respective one of the two first eccentric wheels 44 and a respective one of the two second eccentric wheel assemblies 45 sequentially along a direction away from the transmission wheel 42; two tail ends of the left and right sides of the transmission shaft 43 are rotatably connected to outer shaft sleeves 46 respectively, and the outer shaft sleeves 46 are fixedly installed on a periphery of the machine core lower shell 2. Two portions of the transmission shaft 43 between the transmission wheel 42 and an inner side of each of the two first eccentric wheels 44 facing towards the transmission wheel 42 are rotatably provided with two inner shaft sleeves 47 respectively; the two inner shaft sleeves 47 are fixed between the machine core lower shell 2 and the machine core upper cover 1 to strengthen the supporting function of the transmission shaft 43.

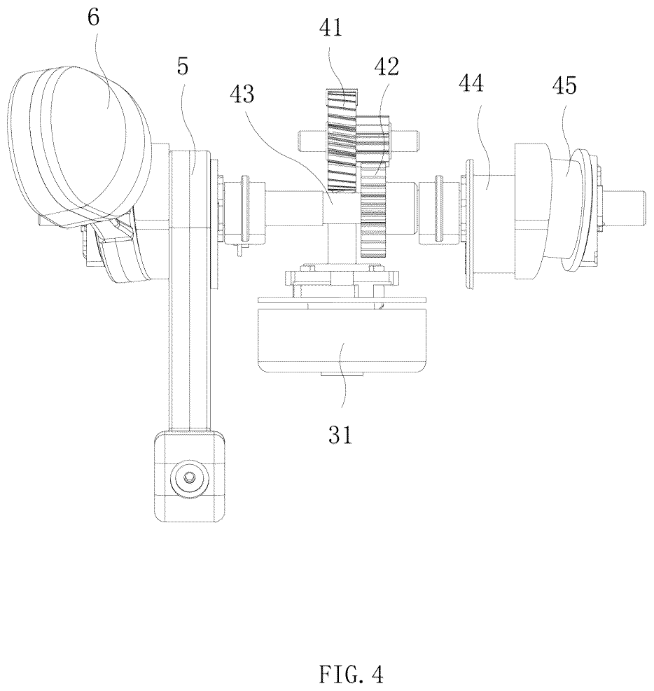

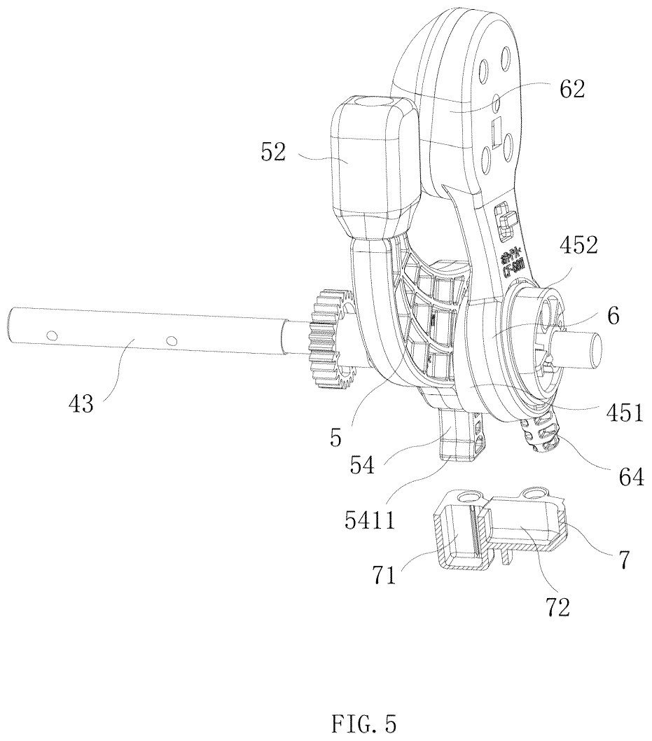

With reference to FIGS. 4 and 5, since the two sides of the massage machine core 10 are designed to be symmetrical, the embodiment described below is referenced only to the first massage unit 5 and the second massage unit 6 on one of the two symmetrical sides, namely a right side, of the massage machine core 10.

The first massage unit 5 comprises a first rocker arm 51 extending forward and being arc-shaped, a first massage head 52 installed at a front end of the first rocker arm 51, a first connection sleeve hole 53 formed at a rear end of the first rocker arm 51, and a first limiting column 54 extending downward from a bottom side of the rear end of the first rocker arm 51.

A first limiting groove 71 is formed below the transmission shaft 43 corresponding to each first massage unit 5; the first limiting column 54 of the first massage unit 5 is inserted into the first limiting groove 71 such that the first limiting column 54 is vertically movable in the first limiting groove 71 but limited from moving back and forth in the first limiting groove 71 along a front-rear direction; the first limiting groove 71 is formed on a limiting block 7, and the limiting block 7 is fixed and locked on the machine core lower shell 2.

A depth of the first limiting groove 71 corresponds to a length of the first limiting column 54; at least a portion of the first limiting column 54 has a front-rear thickness smaller than a distance between a front side wall and a rear side wall of the first limiting groove 71 at least at an opening of the first limiting groove 71, so that a clearance S2 exists between at least a portion of the first limiting column 54 and at least the opening of the first limiting groove 71 to allow oscillation of the first limiting column 54 as will be explained below.

Each of the two first eccentric wheels 44 is provided with a first eccentric wheel connection part 441, which is rotatably inserted into the first connection sleeve hole 53 of the first rocker arm 51 of a corresponding first massage unit 5.

Therefore, with reference to the first massage unit 5 on the right side of the massage machine core 10, when the drive unit 3 drives the worm wheel 41 to rotate, and the worm wheel 41 transmits the rotation to the transmission wheel 42 and the transmission shaft 43, the transmission shaft 43 drives the first eccentric wheel 44 corresponding to the first massage unit 5 on the right side of the massage machine core 10 to rotate, and because the first eccentric wheel 44 and the transmission shaft 43 are not concentric, the rear end of the first rocker arm 51 connected to the first eccentric wheel 44 through the first eccentric wheel connection part 441 is driven to perform a circular, and more specifically, elliptical motion. Specifically, when the rear end of the first rocker arm 51 connected with the first limiting column 54 is driven to perform said circular motion, the first limiting column 54 reciprocates like a piston in the first limiting groove 71 while oscillating back and forth along the front-rear direction as the first limiting column 54 reciprocate. Due to limitation by the first limiting groove 71 on the first limiting column 54, direction and amplitude of the circular motion of the rear end of the first rocker arm 51 is limited, and due to the structural linkage of the first rocker arm 51, the circular motion of the rear end of the first rocker arm 51 is simultaneously performed by the first massage head 52 at the front end of the first rocker arm 51 wherein the first massage head 52 reciprocates up and down along a vertical plane and oscillates back and forth along the front-rear direction as the first massage head 52 reciprocates up and down to achieve a circular motion, thereby performing kneading massages on a shoulder of a user.

In this embodiment, an outer end of the first limiting column 54 is provided with reinforcing protrusions 541 protruding towards a front side and a rear side of the first limiting column 54 respectively, a side surface 5411 of each of the reinforcing protrusions 541 is an arc surface, and the front-rear thickness of the outer end of the first limiting column 54 where the reinforcing protrusions 541 are provided is substantially equal to the distance between the front side wall and the rear side wall of the first limiting groove 71. The arrangement of the reinforcing protrusions 541 can enhance the structural strength of the first limiting column 54 and makes the first limiting column 54 more wear-resistant. Said clearance S2 exists between the front-rear thickness of a portion of the first limiting column 54 above the reinforcing protrusions 541 and the distance between the front side wall and the rear side wall of the first limiting groove 71, so that the first limiting column 54 may oscillate when reciprocating up and down in the first limiting groove 71. The arrangement of the clearance S2 can prevent the first limiting column 54 from interfering with the front side wall and the rear side wall at least at the opening of the first limiting groove 71, such that the first limiting column 54 is allowed to oscillate in the first limiting groove 71 when reciprocating up and down in the first limiting groove 71.

A main body (portion of the first limiting column 54 above the reinforcing protrusions 541) of the first limiting column 54 of this embodiment may be a rectangular structure; the first limiting column 54 may be provided with a plurality of holes that serve to reduce the use of plastics.

With reference to the second massage unit 6 on the right side of the massage machine core 10, the second massage unit 6 comprises a second rocker arm 61 extending upwardly, a second massage head 62 installed at an upper end of the second rocker arm 61, a second connection sleeve hole 63 formed at a lower end of the second rocker arm 61, and a second limiting column 64 extending downwardly from a bottom side of the lower end of the second rocker arm 61.

A second limiting groove 72 is formed below the transmission shaft 43 corresponding to each second massage unit 6; the second limiting groove 72 is disposed on an outer side of the first limiting groove 71, the second limiting column 64 is inserted into the second limiting groove 72 such that the second limiting column 64 is horizontally movable along a left-right direction but limited from moving back and forth along a front-rear direction; the second limiting groove 72 may also be formed on the limiting block 7.

A depth of the second limiting groove 72 corresponds to a length of the second limiting column 64; the second limiting groove 72 extends along the left-right direction to enable the second limiting column 64 to oscillate along the left-right direction, and a length of the second limiting groove 72 along the left-right direction may be equal to the a length of a corresponding second eccentric wheel assembly 45.

Each of the two second eccentric wheel assemblies 45 comprises an inner eccentric wheel 451 and an outer eccentric wheel 452; opposite surfaces of the inner eccentric wheel 451 and the outer eccentric wheel 452 are arranged as corresponding inclined surfaces. The inclined surface of the inner eccentric wheel 451 facing towards the inclined surface of the outer eccentric wheel 452 is provided with a inner eccentric wheel connection part 453; the transmission shaft 43 eccentrically penetrates through each of the second eccentric wheel assemblies 45; an axis of the inner eccentric wheel connection part 453 is tilted with respect to an axis of the transmission shaft 43, and the inner eccentric wheel connection part 453 is rotatably inserted into the second connection sleeve hole 63 of the second rocker arm 61 of a corresponding second massage unit 6.

Therefore, with reference to the second massage unit 6 on the right side of the massage machine core 10, when the drive unit 3 drives the transmission shaft 43 to rotate, the transmission shaft 43 drives the inner eccentric wheel 451 and the outer eccentric wheel 452 of the corresponding second eccentric wheel assembly 45 to eccentrically rotate; as the inner eccentric wheel 451 and the outer eccentric wheel 452 rotate, the inclined surfaces of the inner eccentric wheel 451 and the outer eccentric wheel 452 as well as the inner eccentric wheel connection part 453 provided on the inner eccentric wheel 451 will be inclined in different orientations with respect to an axis of rotation of the inner eccentric wheel 451 and the outer eccentric wheel 452, and when coupled with the fact that the inner eccentric wheel 451 and the outer eccentric wheel 452 is eccentric with respect to the transmission shaft 43, the second rocker arm 61 performs a circular, in particular elliptical motion by oscillating along the left-right direction in the second limiting groove 72 along a substantially horizontal plane and also oscillating back and forth along the front-rear direction as the second rocker arm 61 oscillates along the left-right direction in the second limiting groove 72, and since the second massage head 62 is installed at the upper end of the second rocker arm 61, the same circular motion is performed by the second massage head 62, thereby enabling the second massage head 62 to perform kneading massages on the neck of the user.

The second limiting column 64 of this embodiment may be cylindrical, which is convenient for oscillating in the second limiting groove 72, and the second limiting column 64 may be provided with holes that serve to reduce the use of plastics.

In each limiting block 7, the first limiting groove 71 and the second limiting groove 72 of this embodiment are integrally formed on the limiting block 7 and are independent from each other, and the limiting block 7 is fixed and locked on the machine core lower shell 2, and the limiting block 7 can be made of wear-resistant materials, such as POM (Polyoxymethylene), thereby improving wear-resistance and thus prolonging the service life.

Of course, in each limiting block 7, the first limiting groove 71 and the second limiting groove 72 may communicate with each other, or may be directly formed on the machine core lower shell 2.

On each side of the massage machine core 10, by providing the first limiting column 54, the second limiting column 64 and the limiting block 7, it is convenient for limiting the positions of the first massage unit 5 and the second massage unit 6; after the limiting block 7 is fixed and locked, it is only required to insert the first limiting column 54 and the second limiting column 64 into the first limiting groove 71 and the second limiting groove 72 respectively.

On each side of the massage machine core 10, as the first massage unit 5 and the second massage unit 6 are connected to the same transmission shaft 43, the assembly and installation can be more convenient; when the transmission shaft 43 rotates, the first massage unit 5 and the second massage unit 6 are driven to perform kneading massages synchronously, thereby achieving a better massage effect.

The above descriptions are only preferred embodiments of the present invention, and the protection scope of the present invention is not limited to the above embodiments, and all technical solutions that are based on the teachings of the present invention shall fall within the protection scope of the present invention. It should be noted that for those of ordinary skill in the art, variations and modifications that achieve equivalent technical effects without departing from the principle of the present invention shall remain within the protection scope of the present invention.

1. A massage apparatus, comprising a massage machine core; the massage machine core comprises a drive unit, a transmission unit, a plurality of first massage units, and a plurality of second massage units; the drive unit drives a transmission shaft of the transmission unit to rotate; the plurality of first massage units and the plurality of second massage units are all connected to the transmission shaft and driven by rotation of the transmission shaft to at least oscillate;
each of said plurality of first massage units is capable of at least oscillating along a front-rear direction of the massage apparatus; the transmission shaft extends along a left-right direction of the massage apparatus, and each of two sides of the transmission shaft is fixed with at least one first eccentric wheel; each of said plurality of first massage units comprises a first rocker arm extending forward towards a front side of the massage apparatus, a first massage head installed at a front end of the first rocker arm, and a first connection sleeve hole formed at a rear end of the first rocker arm; the first connection sleeve hole rotatably receives a corresponding first eccentric wheel; a first limiting column is also provided extending downwardly from a bottom side of the rear end of the first rocker arm;
a first limiting groove, formed below the transmission shaft, is provided for each of said plurality of first massage units; the first limiting column of each of said plurality of first massage units is inserted into a respective first limiting groove, such that the first limiting column is vertically movable in the first limiting groove but limited from moving back and forth in the first limiting groove along the front-rear direction of the massage apparatus, and wherein a depth of the first limiting groove allows the first limiting column to be vertically movable therein, and at least a portion of the first limiting column has a thickness along the front-rear direction of the massage apparatus smaller than a distance between a front side wall and a rear side wall of the first limiting groove at least at an opening of the first limiting groove, so that a clearance exists between said at least a portion of the first limiting column and at least the opening of the first limiting groove.

2. (canceled)

3. The massage apparatus of claim 1, wherein the massage machine core also comprises a machine core lower shell; the drive unit, the transmission unit, said plurality of first massage units, and said plurality of second massage units are mounted on an upper side of the machine core lower shell; the first limiting groove is formed on a limiting block, and the limiting block is fixed and locked on the machine core lower shell.

4. The massage apparatus of claim 3, wherein the limiting block is made of wear-resistant material.

5. The massage apparatus of-s wherein each of said plurality of second massage units is capable of at least oscillating along the left-right direction of the massage apparatus; each of said two sides of the transmission shaft is also fixed with at least one second eccentric wheel assembly positioned on an outer side of said at least one first eccentric wheel;
each of said plurality of second massage units comprises a second rocker arm extending upwardly, a second massage head installed at an upper end of the second rocker arm, and a second connection sleeve hole formed at a lower end of the second rocker arm; the second connection sleeve hole rotatably receives a corresponding second eccentric wheel assembly. and a second limiting column is provided extending downwardly from a bottom side of the lower end of the second rocker arm:
a second limiting groove, formed below the transmission shaft, is provided for each of said plurality of second massage units; the second limiting column of each of said plurality of second massage units is inserted into a respective second limiting groove, such that the second limiting column is horizontally movable along the left-right direction of the massage apparatus but limited from moving back and forth along the front-rear direction of the massage apparatus; the second limiting groove is disposed on an outer side of the first limiting groove; a depth of the second limiting groove corresponds to a length of the second limiting column; the second limiting groove extends along the left-right direction of the massage apparatus to enable the second limiting column to oscillate along the left-right direction of the massage apparatus;
each of said at least one second eccentric wheel assembly comprises an inner eccentric wheel and an outer eccentric wheel; opposite surfaces of the inner eccentric wheel and the outer eccentric wheel are arranged as corresponding inclined surfaces; the inclined surface of the inner eccentric wheel facing towards the inclined surface of the outer eccentric wheel is provided with a inner eccentric wheel connection part; the transmission shaft eccentrically penetrates through each of said at least one second eccentric wheel assembly; an axis of the inner eccentric wheel connection part is tilted with respect to an axis of the transmission shaft, and the inner eccentric wheel connection part is rotatably inserted into the second connection sleeve hole of the second rocker arm of a corresponding second massage unit.

6. The massage apparatus of claim 5, wherein the first limiting groove and the second limiting groove are formed on a limiting block; the limiting block is fixed and locked on a machine core lower shell of the massage machine core.

7. The massage apparatus of claim 6, wherein the limiting block is made of wear-resistant material.

8. The massage apparatus of claim 1, wherein an outer end of the first limiting column is provided with reinforcing protrusions protruding towards a front side and a rear side of the first limiting column respectively; said clearance exists between the thickness along the front-rear direction of the massage apparatus of a portion of the first limiting column above the reinforcing protrusions and the distance between the front side wall and the rear side wall of the first limiting groove; a front-rear thickness of the outer end of the first limiting column where the reinforcing protrusions are provided is equal to the distance between the front side wall and the rear side wall of the first limiting groove.

9. The massage apparatus of claim 8, wherein a side surface of each of the reinforcing protrusions is an arc surface.

10. The massage apparatus of claim 1, wherein each of said two sides of the transmission shaft is provided with at least one of said plurality of first massage units and at least one of said plurality of second massage units.

11. The massage apparatus of claim 1, wherein the massage apparatus also comprises a machine core upper cover and a machine core lower shell;
the drive unit is installed in an installation space defined by an enclosure formed by the machine core upper cover and the machine core lower shell connected to each other, and the drive unit comprises a drive motor, a battery, and a worm connected to an output end of the drive motor; the battery is configured to supply power to the drive motor;
the transmission unit also comprises a worm wheel and a transmission wheel; the worm wheel is rotatably installed in the installation space and comprises a helical gear and a spur gear which are coaxially arranged; the helical gear and the worm engage with each other, the spur gear and the transmission wheel engage with each other; the transmission wheel is coaxially fixed with the transmission shaft.

12. The massage apparatus of claim 11, wherein two tail ends of said two sides of the transmission shaft are rotatably connected to outer shaft sleeves respectively, and the outer shaft sleeves are fixedly installed on a periphery of the machine core lower shell.
